(19) United States
(12) Patent Application Publication
(10) Pub. No.: US 2015/0273321 A1
(43) Pub. Date: Oct. 1, 2015

(54) Interactive Module

(71) Applicants: Eric P. Schwartz, Austin, TX (US); Eric N. Abrahams, Austin, TX (US)

(72) Inventors: Eric P. Schwartz, Austin, TX (US); Eric N. Abrahams, Austin, TX (US)

(73) Assignee: E-SQUARED LABS, INC., Austin, TX (US)

(21) Appl. No.: 14/242,110

(22) Filed: Apr. 1, 2014

(51) Int. Cl. A63F 13/211

(52) U.S. Cl. CPC A63F 13/211

(57) ABSTRACT

An interactive module is configured to determine that another interactive module is proximate to the first interactive module and then to engage in communications that relate a game or activity. Utilizing position identification circuitry and/or acceleration determination circuitry, the module identifies a defined active motion based upon data generated by at least one of the position determination circuitry and the acceleration circuitry. The module then, based on the determined proximity and the identified active motion, stores an indication of an event and exchanges data based upon identifying the defined active motion directly with the second interactive module. The indication of the event can be, for example, either a counter value or a score. In one embodiment, the record keeping is based in part, upon the activity of the module and also in part by an identity of the proximate interactive module.

### BACKGROUND

1. Technical Field

The present invention relates to interactive game and activity modules and, more particularly, devices for use in single and group game and activity situations.

2. Related Art

The Golden age for gaming systems started in the 1980s. Some of the industry's first contenders were Sega, Genesis and Nintendo. During the 1990s, Nintendo and Sega became the Giants of gaming systems until Sony came into the market forever changing the types of systems that were available and their capabilities. These gaming systems brought the pleasures of an arcade into the home. Traditionally, a gaming system included a gaming console, at least one port for receiving a hardware module that included software that defined game rules, graphics software and instructions, and at least two connector ports for input devices such as joysticks, keypads, etc. One aspect of each of these original gaming systems is that the joysticks or other input devices were all physically tethered to the gaming console.

In the late 1990s and early 2000's, handheld gaming devices became popular in which a stand alone system included a display, at least one speaker, and internal logic for generating graphics and for defining the game. The technology for the larger and more traditional gaming systems progressed wherein input devices communicated with the game controller via a wireless communication link instead of via a wired tether. While the input devices for these new systems were wireless, they typically consisted of keypads with various control buttons and joysticks and were limited to use within a close distance to the game console due to limitations in the communication technology.

Recently, the nature of the input devices changed wherein the input devices includes accelerometers and communication circuitry that provide an indication of motion to the console unit via a wireless communication link. For one example of such technology, the Nintendo Wii® includes input devices that can be held in the palm of a hand, such as a racket or baton, that includes the accelerometers to support games that are related to activities such as tennis, bowling, boxing and golf. The Nintendo Wii input devices do not, however, include control software or game logic. They merely transmit action/selection indication signals to the gaming console that are based upon one or more button depressions and/or a movement. The movements are not necessarily well-defined and technically correct actions. In usage, it appears that the primary data being transmitted is related to speed and acceleration and not so much to a specified action in a specified direction.

The input devices for the Nintendo Wii, while being wireless, are required to be within a close distance to the gaming console and to communicate with the gaming console to deliver action/selection information. The user's actions are prompted by what is shown on a television screen.

While many wonderful applications have been and can be developed for such technology, there are limitations that are inherent to the current form factors that require interaction between the input devices and the gaming console. The present inventors have realized, therefore, that what is needed, therefore are devices that are not limited by current technology form factor based constraints to facilitate the creation of new games and activities.

### SUMMARY OF THE INVENTION

The present invention is directed to an apparatus and methods of operation that are further described in the following Brief Description of the Drawings, the Detailed Description of the Invention, and the Claims. Other features and advantages of the present invention will become apparent from the following Detailed Description of the Invention made with reference to the accompanying drawings. In general, however, the present invention is directed to an apparatus and associated methods for an interactive module and a network of interactive modules that are configured and operable to determine that they are proximate to each other and to interact with each other according to game/activity rules. The interaction can include exchanging defined actions, games and game rules, scoring and communication rules, and scores and recorded data. The games, game rules, interactive behavior, scoring rules, communication rules and basic operation rules are all user definable and can be relayed directly between devices using device-to-device communications. As such, a mesh network of the interactive modules may be created. These and other aspects of the embodiments of the invention will be described in relation to the figures and descriptions that follow.

More specifically, the method by a first interactive module may include determining that a second interactive module is proximate to the first interactive module and utilizing at least one of a position identification circuitry and an acceleration determination circuitry to identify (or to create) a defined active motion based upon data generated by at least one of the position determination circuitry and the acceleration circuitry. The method further includes establishing a communication link with the second interactive module using one of a personal area network protocol or a near field communication protocol or a WLAN or Wi-Fi communication protocol.

Based on the determined proximity and the identified active motion or action, the method includes storing an indication of an event, which can be in the form of a score, and exchanging data between the interactive modules based upon identifying the defined active motion or action.

Determining that the second interactive module is proximate to the first interactive module includes at least one of electronically detecting the second interactive module and receiving location information of another (second) interactive module and evaluating the location information in relation to a known location of the present (first) interactive module.

### BRIEF DESCRIPTION OF THE DRAWINGS

A better understanding of the present invention can be obtained when the following detailed description of the preferred embodiment is considered with the following drawings, in which:

FIG. 1 is a functional network diagram containing a plurality of interactive modules according to one embodiment of the invention.

FIG. 2 is a functional block diagram of an interactive module according to one embodiment of the invention.

FIG. 3 is a functional block diagram of an interactive module 100 that includes a base unit and an interchangeable unit.

FIG. 4 is a functional block diagram illustrating one embodiment of the invention.

FIG. 5 is a series of drawings that illustrates a plurality of movement patterns for exemplary purposes.

FIG. 6 is a functional block diagram of an action recognition module according to one embodiment of the invention.

FIG. 7 is a flow chart illustrating a method according to one embodiment of the invention.

FIG. 8 is a flow chart that illustrates a method according to one embodiment of the invention.

FIG. 9 is a flow chart that illustrates an interactive method between two interactive modules according to one embodiment of the invention.

FIG. 10 is a flow chart that illustrates one aspect of an embodiment of the present invention.

FIG. 11 is a flow chart that illustrates one aspect of an embodiment of the present invention.

FIG. 12 is a signal flow diagram that illustrates a method according to one embodiment of the invention for defining game/activity rules.

FIG. 13 is a functional diagram illustrating a network of interactive modules that operate according to one embodiment of the invention.

FIG. 14 is a flow chart that illustrates a method of communication in a network of interactive devices according to one embodiment of the invention.

### DETAILED DESCRIPTION OF THE DRAWINGS

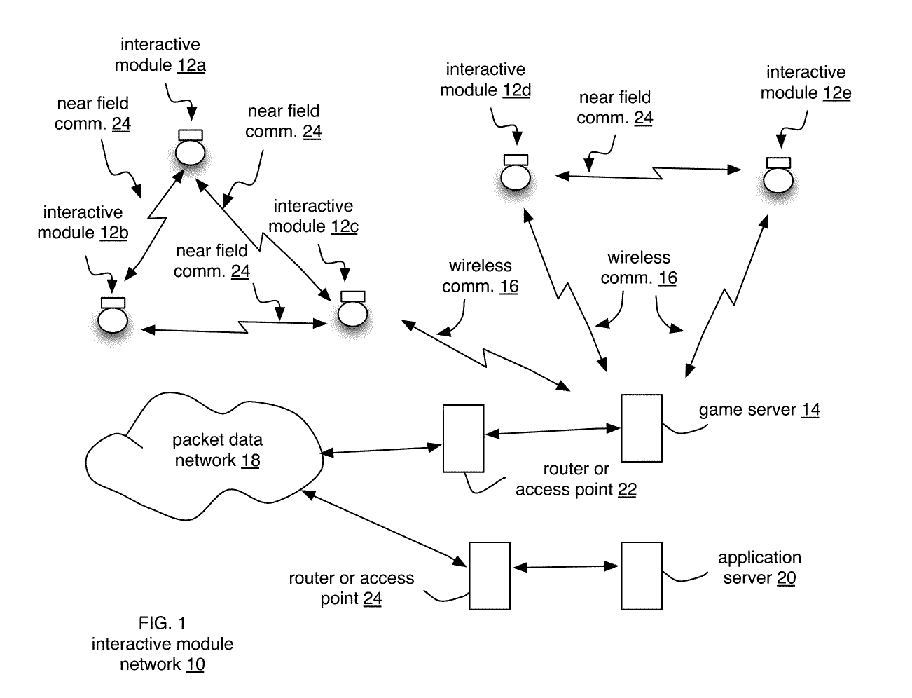

FIG. 1 is a functional network diagram containing a plurality of interactive modules according to one embodiment of the invention. Referring to FIG. 1, an interactive module network 10 includes a plurality of interactive modules 12a-12e that are configured to communicate directly with each other in a device-to-device (D2D) mode as well as communicating via one or more of a router, access point, or game/activity server 14 via a data packet network such as the Internet. In one embodiment, a game/activity server 14 (hereinafter, game server 14 or GS 14) initializes a game or activity via a wireless communication link 16. A GS 14 may be a dedicated device or a computing unit with an associated program or application.

In one embodiment, the wireless communication link 16 is a WLAN communication link such as those defined by the various I.E.E.E. 802.11 communication protocols. Other communication protocols may also be used. For example, the wireless communication link may be one according to a Bluetooth protocol or a personal area network (PAN) protocol. It should be noted, that the interactive modules also may be configured to initiate a game or activity. In one embodiment, a defined motion of the interactive module may, upon being recognized by internal logic within the interactive module, trigger a method or process to initiate the game or activity.

A GS 14 may be a standalone device having game/activity rules and logic installed within its memory and/or circuitry. Alternatively, GS 14 may include or be in communication with a wireless router or access point 22 that is communicatively coupled to a packet data network 18 such as one of the many versions of the Internet to ultimately communicate with a remote application server 20 via a router or access point 24.

Each of the interactive modules 12a-e is configured to communicate with GS 14 via a first wireless communication link 16 as well as with each other according to any one of a plurality of D2D communication protocols such as I.E.E.E. 802.15 or a personal area network communication protocol (e.g., Bluetooth) or a near-field communications (NFC) protocol such as NFC communication link 24. Here in FIG. 1, wireless communication link 16 is a WLAN type communication link that operates according to one ore more I.E.E.E. 802.11 type communication standards. Communication link 24 is illustrated as a Near Field Communications (NFC) communication link but it should be understood that the invention is not so limited. Any peer-to-peer type of communication link may be used that supports device-to-device communications.

In operation, a method for the interactive modules comprises determining that a second interactive module is proximate to the first interactive module, and utilizing at least one of a position identification circuitry and an acceleration determination circuitry to identify a defined active motion based upon data generated by the at least one of the position determination circuitry and the acceleration circuitry.

In one embodiment of the invention, devices such as the first and second interactive modules are operable to determine that they are proximate to each other by detecting a beacon transmitted by the other device and/or a radiofrequency signal that can only be received and recognized within a certain range or distance. In an alternative embodiment, a remote device, such as a game server, generates a communication signal to the interactive devices to inform them that they are proximate to each other. For example, if each interactive module has a position determination circuit, such as a global positioning system (GPS) receiver, the interactive modules can forward location information to the game server, here game server 14, to enable game server 14 to determine with specified logic that the first and second interactive devices are proximate to each other. Once such a determination is made, the game server 14 communicates with the first and second interactive modules to advise them that they are proximate to each other. Alternatively, game server 14 may transmit position information of at least one of the first and second interactive modules to allow one or both of the interactive modules to determine that the other is proximate.

Once the first and second interactive modules have determined that they are proximate to each other, then they may enter into a game or activity mode or, alternatively, a communication mode to exchange game/activity rules or game/activity data (generally, game/activity information). For example, utilizing at least one of position identification circuitry and acceleration determination circuitry, the first interactive module is configured to identify a defined active motion based upon data generated by the position determination circuitry and/or acceleration circuitry that prompts the first interactive module to enter into a corresponding game or activity mode and/or to initiate communications with the second interactive module to jointly enter into the corresponding game or activity mode or to exchange the game/activity information.

Once the first interactive module has not only determined that it is proximate to the second interactive module, but also that a defined active motion that corresponds to the game or activity has been performed by the user, the first interactive module, after establishing a communication link with the second interactive module, stores an indication of the event (based upon identified and defined active motion) and exchanges game/activity information based upon the identified defined active motion directly with the second interactive module. The exchanged game/activity information may be any one or more of an updated score, an indication of the identified action, or even a command or prompt to trigger a desired response by the user of the second interactive module or rules for the game/activity.

In one embodiment of the invention, each interactive module includes memory that stores a library of defined moves and activities. The library of defined moves includes moves that are interactive by nature, such as performing a high five, shaking hands, boxing, dancing, rock paper scissors, copycat moves, exercise moves, hugging, secret handshakes and communication gestures as well as moves for virtual games such as virtual ping-pong.

The library of defined moves also includes moves that are singular and not interactive. For example, the library of the fine moves may relate to identifiable moves such as jogging, tooth brushing, rope jumping, jumping jacks, etc. It should be understood, of course, that the library of defined moves might require the interactive module to be worn on a specified body part to be able to properly identify and record the activity.

Generally, the interactive module may be used not only as a gaming device, but also as a part of a system that encourages certain behaviors and activities such as exercise or tooth brushing. Because the interactive modules are configured to keep a score, or tally or records according to a set of rules, minimum thresholds of certain activities may be defined and subsequently rewarded. For example, the interactive module can not only track how many steps a person walks, how many exercises of a certain type are performed, such as bench presses or jumping jacks, but also other activities such as how many strokes a child used to brush his or her teeth to ensure that the teeth are being brushed properly. Accordingly, award systems may be defined via a user interface to generate an award or recognition of specified accomplishments.

Additionally, because the interactive module is configured to enter into a selected mode, game or activity upon determining that another interactive module is proximate, special games may be created and/or defined. For example, the childhood game of tag may be modified to utilize a virtual token that is handed off from one person (or more specifically, one interactive module) to another when the two individuals or devices come into contact with (within a defined distance) each other.

In keeping with the above, games and activities may be defined that require participation by a group of individuals. Additionally, the individuals may be organized into separate groups wherein the scorekeeping or tally is based not only on interaction, but also upon organization or arrangement. Games may be defined, for example, that have two or more teams wherein scoring is based upon an activity in relation to the identity or membership of a proximate individual. One significant aspect of the embodiments of the present invention, therefore, is that record-keeping, which includes keeping a score or tally, depends not only upon identified actions being performed, but also upon determining a relative proximity of an individual or specified device and the group and/or individual identity of that user or user device.

Additionally, once the interactive module determines that it is proximate to another device, or has just become proximate, the interactive module is configured to identify actions that serve as a command to enter into a game or activity or mode. The game, activity or mode that is entered into may be based on the identity of the proximate interactive device and, possibly, the present mode of the interactive module. Thus, depending on the present mode when the second interactive module becomes proximate to the first interactive module, a subsequent mode or activity may be defined that affects how defined actions are scored, recorded, or tallied.

More generally, the capabilities of the interactive modules are intended to encourage fitness and movement, to make individual and group activities more fun, to reward positive behavior, whether individualized or as a part of a group, and to create a unique physical social network. If an interactive module is configured to determine when it is proximate to a specified computer, gaming device, or server, the defined actions may be utilized in conjunction with certain activities for online gaming. Similarly, the interactive module may interact with external devices such as smart phones and accessories of other types to generate commands or data to be transmitted to the extern devices.

As another aspect of the embodiments of the present invention, the interactive modules may be configured to record certain types of activities and motions that are later uploaded to a remote server via an access point and data packet network such as the Internet. For users that allow such data collection to occur, the data may be utilized to improve target marketing and/or product development. For example, it is known that there are companies that collect such data to render their advertising and product development efforts more efficient and effective.

The embodiments of the interactive modules bus include any one of a number of different types of motion and position recognition circuits, devices and systems such as accelerometers, gyroscopes, magnetometers and GPS receivers that may be utilized either singly or in combination to identify location, movement, actions, orientation, speed and acceleration. Any reference herein to position identification circuitry and acceleration determination circuitry should be understood to potentially include any combination of accelerometers, gyroscopes, magnetometers and GPS receivers.

The interactive modules may be packaged or physically configured to be wrist worn (as a watch), or to be worn on other limbs or locations of the body such as the head, leg, upper arm or torso. Generally, the interactive modules will be configured to be stylish or attractive and comfortable to wear as well as to be durable.

Additionally, the interactive modules will include communication circuitry to enable data to be uploaded and downloaded to facilitate coordination, communication and control. For example, in one embodiment, and interactive module may include a USB port to enable the device to be coupled to a computer. Alternatively, or additionally, the interactive modules can include a wireless communication radio and corresponding protocol logic to enable the interactive module to communicate with a computer via a wireless link such as a Bluetooth or a Wi-Fi or WLAN communication protocol such as I.E.E.E. 802.11. The logic would, in the case of Bluetooth, as well as other protocols, include pairing logic to enable the two devices to be paired for subsequent communications.

As another aspect of the embodiments of the present invention, the interactive modules may be configured to store user location information in relation to a downloaded map that is stored in memory to allow a parent to understand where the user, e.g., a child, has gone during the day. Moreover, in one embodiment, such a downloaded map includes defined prohibited areas that prompts the interactive module to generate alarms to remind the user that he or she is within or approaching a prohibited area. In yet another embodiment of the invention, the interactive module includes wireless communication circuitry to enable it to generate text messages for transmission via any one of a cellular communication protocol, a WLAN communication protocol such as 802.11 or a personal area network communication protocol such as Bluetooth to a specified user such as a parent to inform the specified user of the location and/or activity of the person using the interactive module.

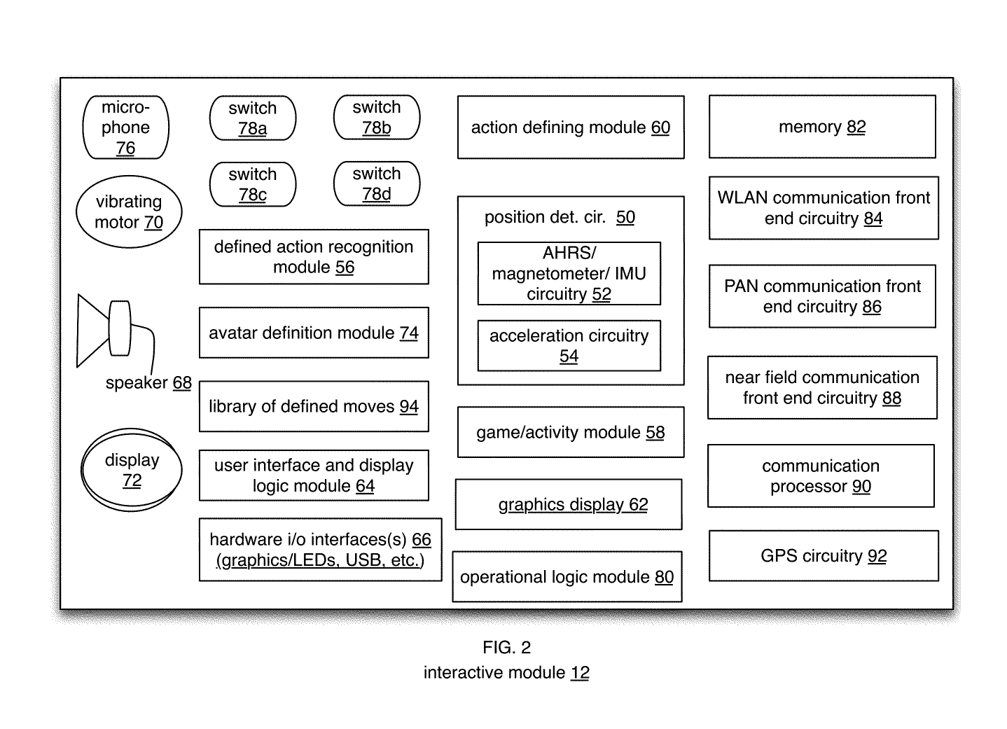

FIG. 2 is a functional block diagram of an interactive module according to one embodiment of the invention. Referring to FIG. 2, interactive module 12 (which can be anyone of modules 12a-e of FIG. 1 includes modules that support communications, motion and position and location determination, game and activity rules, displays, interface hardware, and at least one module for identifying defined actions as well as user interface modules. All of these modules work in concert to create an interactive module that supports new types of games and activities not previously supported by existing gaming systems and their input devices.

More specifically, interactive module 12 includes position determination circuitry 50 that further includes one or more of an attitude and heading reference system (AHRS), a magnetometer and an inertial measurement unit (IMU) circuitry 52 and acceleration circuitry 54. Interactive module 12 also includes a defined action recognition module 56 that is configured to receive position and/or acceleration data from position determination circuitry 50 to determine if a defined action has been performed.

Interactive module 12 also includes a game/activity module 58 that communicates with defined action recognition module 56 to determine how to interact with another interactive module and/or how to score, record or tally the defined action that was recognized by defined action recognition module 56. For example, game/activity module 58 may include game or activity rules that are process in view of the recognized actions by defined action recognition module 56 to determine how to record an event or even a mode of operation. Additionally, interactive module 12 includes an action-defining module 60 that defines logic for creating a library of defined actions that may be recognized by defined action recognition module 56. Action defining module 60 is configured to receive position and acceleration data from position determination circuitry 50 while in a learning mode and to store the received position and acceleration data to define an action. The defined actions are then stored in a library of defined moves 94.

In one embodiment of the invention, action defining module 60 is configured to communicate with a user via any one of a plurality of user interface devices, such as graphics display 62, user interface and display logic module 64, hardware I/O interfaces 66, speaker 68, vibrating motor 70, and display 72, to generate prompts and/or to receive names or identifiers for the recorded actions. For example, action-defining module 60 may generate a feedback signal to the user asking the user to give a name to a recorded action that has just been defined. If, for example, and action has been defined, action defining module 60 may communicate with graphics display module 62 or with display 72 to generate a text message for the user to request that the user enter a name for the recorded action that has just been defined.

Alternatively, action-defining module may prompt a user in that way by generating a message or a light that is displayed directly by display 72. Alternatively, action defining module 60 may generate a voice message or tone that is played by speaker 68 the prompt the user to enter a name for the defined action. A vibrating motor 70 may also be used as a prompt or a feedback device for communicating with the user.

Another way of communicating with the user is through the use of a customized cartoon image (avatar). Accordingly, interactive module 12 includes an avatar definition module 74 that allows a user to create an avatar for communicating results or messages to the user or to prompt the user to perform a specified action.

As may also be seen, interactive module 12 includes a microphone 76 that allows the user to respond to any prompt generated by any means with a verbal response. For example, if action defining module 60 prompts the user to generate a name for a recently recorded and defined action, any voice that is recognized or received by microphone 76 may be produced to processing logic to convert the same to text which is then associated to the newly defined action by action defining module 60.

Continuing to examine FIG. 2, the interactive module 12 includes a plurality of switches 78a-d that may be used for turning a module on or off as well as to select from a variety of options given to the user via any of the user interface display or sound elements.

More generally, and operational logic module 80 includes operational logic to coordinate the plurality of modules and their associated functions and communications with each other as well as with the user. Moreover, a memory 82 includes temporary computer instructions and data as well as computer instructions and data that are stored on a permanent basis or until deleted or replaced. Other circuits or elements of interactive module 12 include a wireless local area network (WLAN) communication front end circuitry 84, personal area network (PAN) 86, near field communication (NFC) front end circuitry 88, as well as a communication processor 90 and global positioning circuitry (GPS) 92.

Each of the modules, circuits and elements of interactive module 12 may be configured to operate according to the various embodiments of the present invention as described here in relation to FIG. 1 described above as well as the figures described below. An interactive module 12 is not required to include all of the modules shown within FIG. 2 and may include other modules not described here. Moreover, the logic of the various modules may be combined or defined in different manners.

Any logic of graphics display module 62, for example, could be included with user interface and display logic module 64. Alternatively, user interface and display logic module 64 may define interface related logic for various devices including graphics devices while graphics display module 62 generates actual display signals that are to be shown on a display via an interface controlled by user interface and display logic module 64. It should also be understood that the various flow charts described in the present specification may be supported and the logic therefor included within the various modules and circuitry described in relation to FIG. 2.

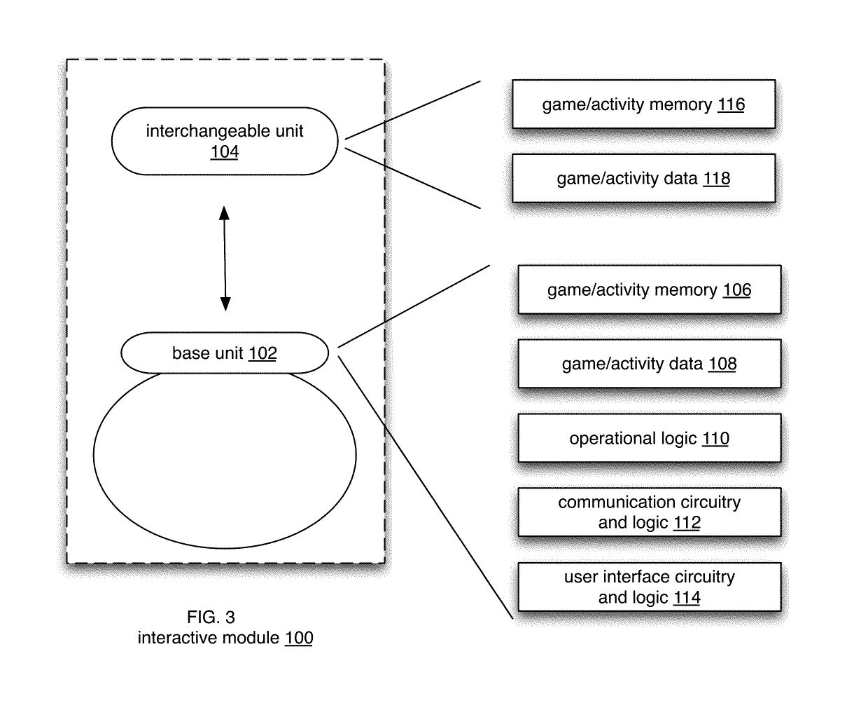

FIG. 3 is a functional block diagram of an interactive module 100 that includes a base unit 102 and an interchangeable unit 104. Interactive module 100 includes a base unit 102 that further includes the elements described in relation to FIG. 2 and/or a game/activity memory module 106, a game/activity data module 108, operational logic module 110, communication circuitry and logic module 112, and user interface circuitry and logic module 114. Interactive module 100 further includes an interchangeable unit 104 that further includes game/activity memory module 116 and game/activity data module 118.

One aspect of the embodiment of FIG. 3 is that interchangeable unit 104 includes a game/activity memory module 116 that is similar to game/activity memory module 106 and a game/activity data module 118 that is similar to game/activity data module 108. These duplicate modules 116 and 118, because they are part of interchangeable unit 104, which may be removed from base unit 102 to be placed on a base unit of another interactive module 100, are required to support sharing of defined motions and record-keeping as the interchangeable units are installed on different base units 102.

Accordingly, when an interactive unit 104 is coupled to a base unit 102, the base unit 102 and interchangeable unit 104 are configured to exchange game/activity data stored in game/activity data modules 118 and 108. For example, if base unit 102 modifies its stored records, for example, a score for a particular game, and also learns a new defined action that is stored within its internal circuitry, such stored records and newly defined action may be uploaded to interchangeable unit 104.

Similarly, when interchangeable unit 104 is coupled to base unit 102, any record-keeping and/or defined actions stored therein may be downloaded to base unit 102. This interoperability allows interchangeable units 104 to be exchanged between users to share defined actions and/or games and/or activities. In one embodiment, time tags are associated with each recorded set of rules/data so older data or rules do not overwrite current rules/data.

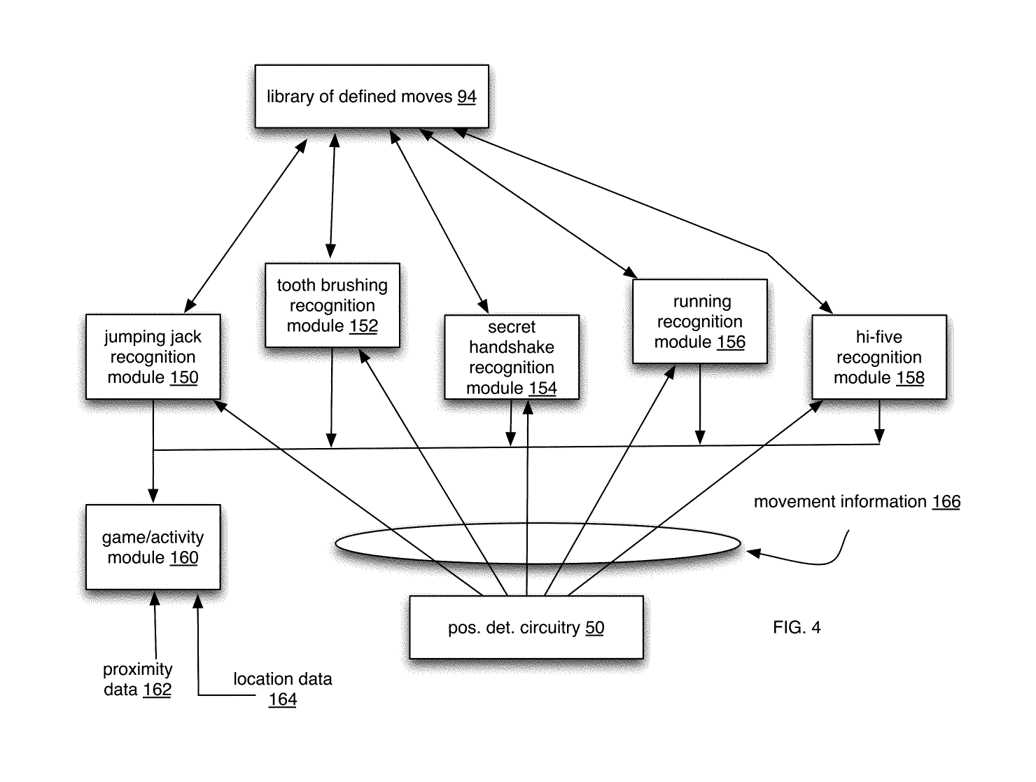

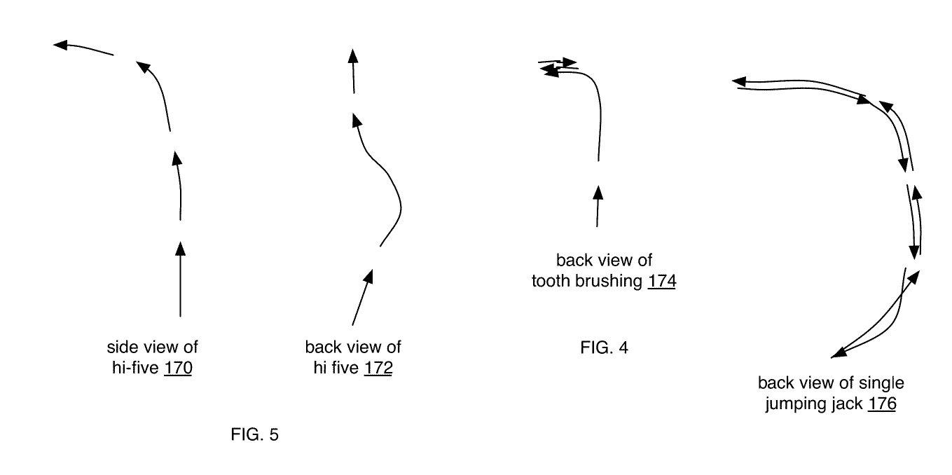

FIG. 4 is a functional block diagram illustrating one embodiment of the invention. In the embodiment of FIG. 4, each of a plurality of modules communicate with both the position determination circuitry 50 and the library of defined moves 94 to determine whether a defined action or movement has occurred. More specifically, the position determination circuitry 50 produces movement information 166, which can comprise location, a movement pattern, and acceleration, or a speed, or combination thereof, to each of a plurality of modules that determine whether a specified action or movement has occurred. In the example of FIG. 4, a jumping jack recognition module 150, a tooth-brushing recognition module 152, a secret handshake recognition module 154, a running recognition module 156 or a high-five recognition module 158 is each coupled to receive movement information 166 from position determination circuitry 50.

Each of these modules is further configured to communicate with the library of defined moves module 94 to compare the received movement information to the library of defined moves to determine if a defined move or action has occurred. If a defined move or action has occurred, each of the modules 150-158 is configured to convey to game/activity module 160 and indication of the recognized move or action. Game/activity module 160 is configured to perform any necessary scoring or record keeping associated with the recognized move or action. As may also be seen, gain/activity module 160 is configured to receive proximity data 162 and location data 164 which may affect the interpretation or record keeping or scorekeeping for the recognized move or action.

FIG. 5 is a series of drawings that illustrates a plurality of movement patterns for exemplary purposes. More specifically, a side view of a high-five 170, a back view of a high-five 172, a back view of tooth brushing 174 and a back view of a single jumping jack 176 are shown. These movement patterns illustrate a portion of the movement information 166 generated by the position determination circuitry 50 (FIG. 2) that may be produced to a defined action recognition module 56 (FIG. 2) or to any of the modules 150-158 (FIG. 4).

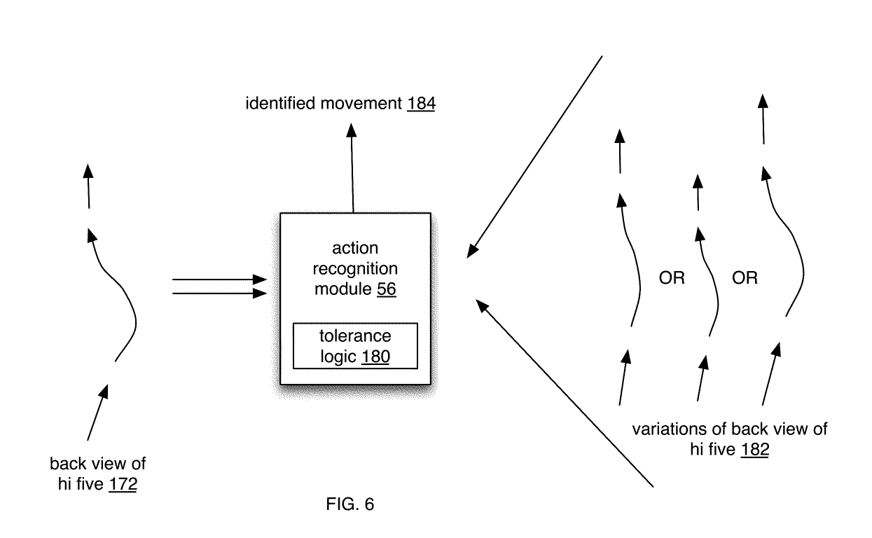

FIG. 6 is a functional block diagram of an action recognition module according to one embodiment of the invention. Action recognition module 56 includes tolerance logic 180 that includes logic for identifying a movement even if the movement is not exactly the same as a defined action. For example, if a defined action is for a high-five, but the movement varies slightly from the defined action, tolerance logic 180 is configured to identify the movement or action even though there is some variation.

To illustrate, for a back view 172 of a high-five (as the defined action), if the actual movement is one of the three variations of the back view of the hi five 182, tolerance logic is configured to determine that the actual movement is the defined action within a range of acceptable variations that allows the action recognition module 56 to identify the action or movement and produce an indication of the identified movement 184.

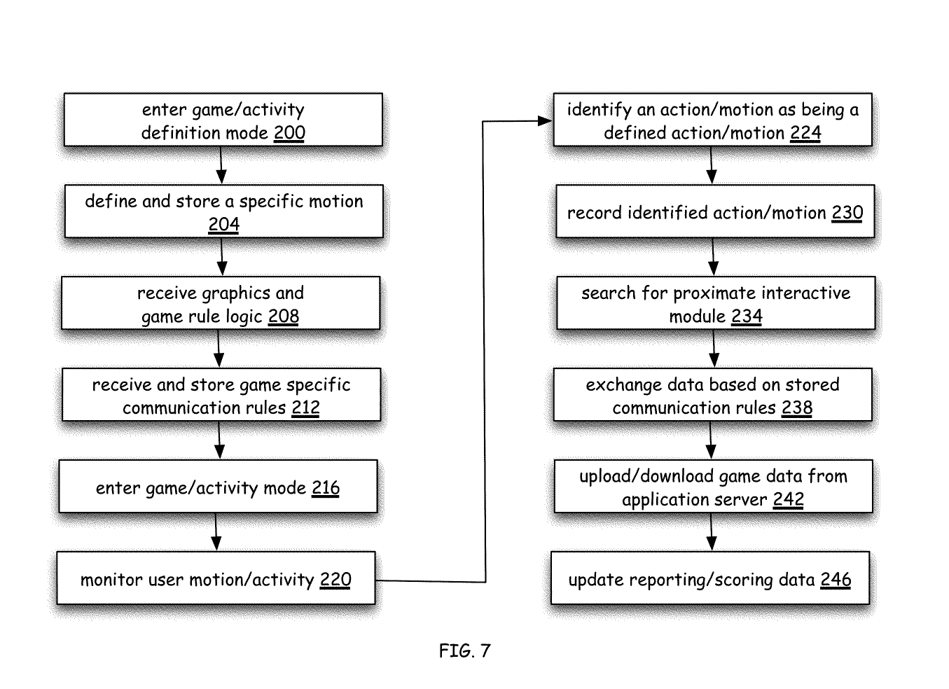

FIG. 7 is a flow chart illustrating a method according to one embodiment of the invention. The method commences with an interactive module entering into a game/activity definition mode (200). The game/activity mode may be initiated in a variant of ways including: a) depressing a control element (button or switch or making a selection based upon a display option), b) powering the interactive module on and then performing a specified action that defines the game/activity definition mode, or c) as a default once the interactive module has been powered on if there are no defined actions stored in memory.

Thereafter, the method includes defining and storing a specific motion or action (204). The step of receiving and storing one or more actions or motions is one step that is required for a game or activity. Another step that may occur prior to or subsequent to recording specific actions or motions the step of receiving graphics and game rule logic (208) in addition to receiving and storing game specific rules and communication rules (212). For example, once a defined activity is recognized, a game rule may require a score to be recorded and a communication rule may specify when a stored result (e.g., a score) is communicated to another interactive module or to a game console or remote game server via an access point. In one embodiment, the game rules are received from a remote source such as the game console or a remote application server via the Internet and an access point.

Once defined actions are stored and game/activity and communication rules are received or stored, the interactive module is configured to operate in a game or activity mode. Accordingly, the method includes entering into a game/activity mode (216) and monitoring user motion/activity (220). While within a game/activity mode and monitoring data from the position determine circuitry (e.g., position determination circuitry 50 of FIG. 2), the method includes identifying an action/motion as being a defined action/motion (224) and recording an identified action/motion (230). For some games/activities, the interactive module may just record actions/motion without requiring interaction with another interactive module (e.g., exercising, tooth brushing, etc.). For some games/activities, the method includes some level of interaction with another interactive module (even if only for exchanging score or activity information).

For embodiments that require some level of interaction, the method includes searching for proximate interactive module (234) and exchanging data based on stored communication rules (238). The method also includes uploading/downloading game data from an application server or game console (242) and updating reporting/scoring data to the application server or game console (246). For each instance here in the specification, it should be understood that a reference to communicating with a game or application server or with a game console should understood to mean any type of device that operates as a host for a game or activity and communications with an interactive module to provide game/activity rules, to download or upload scores, game rules, etc.

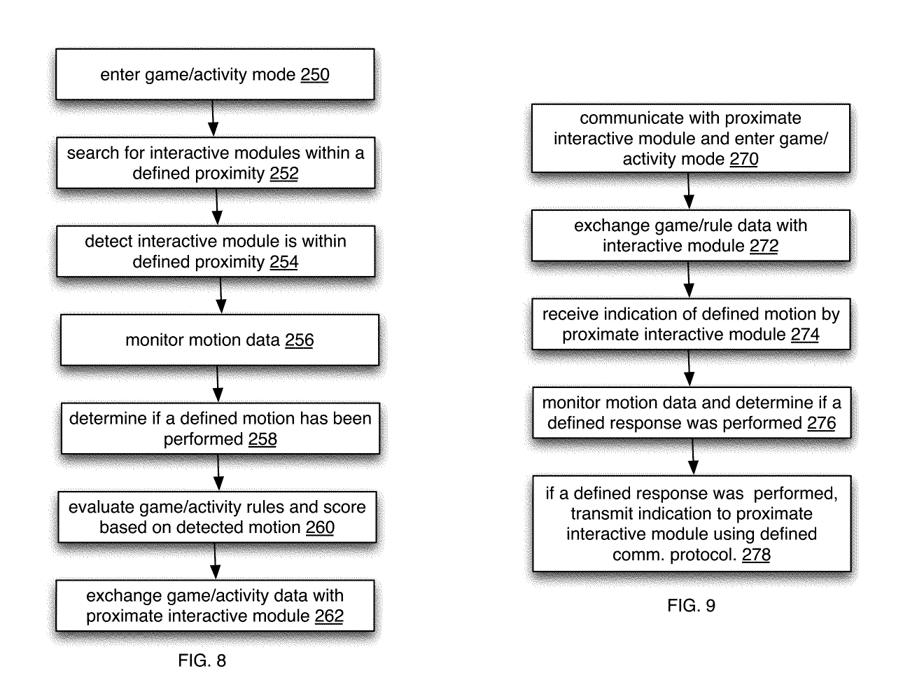

FIG. 8 is a flow chart that illustrates a method according to one embodiment of the invention. The method commences with the step of entering into a game/activity mode (250) and searching for interactive modules within a defined proximity (252). Thereafter, when an interactive module is proximate, the method includes detecting an interactive module is within a defined proximity (254). The defined proximity may be one that is determined via received data from a game console or server and is compared to the interactive modules own location data.

Alternatively, a communication protocol may be used that limits communications to devices that are within a defined distance of each other. For example, near field communication (NFC) technology and protocol may be utilized to initiate a communication between two interactive modules. Thereafter, another communication protocol such as a personal area network (PAN) protocol such as Bluetooth may be used for subsequent communications for games/activities.

Thereafter, the method includes monitoring motion data (256) and determining if a defined motion has been performed (258). If a defined motion or action has been performed, the method includes valuating game/activity rules and recording a score based on the detected motion (260). The method further includes exchanging game/activity data with proximate interactive module (262).

FIG. 9 is a flow chart that illustrates an interactive method between two interactive modules according to one embodiment of the invention. The method commences with an interactive module communicating with proximate interactive module and enter game/activity mode (270). The method further includes the interactive module exchanging game/rule data with the proximate interactive module (272). It should be noted that the interactive module might exchange game/rule data with the proximate interactive module prior to communicating with it to enter into a game/activity mode.

Thereafter, the method includes receiving an indication of defined motion by proximate interactive module (274). Thereafter, the method includes monitoring motion data and determine if a defined response was performed by the interactive module (276). If a defined response was performed, the method includes transmitting an indication of the defined response to the proximate interactive module using a defined communication protocol (278).

One aspect of the method of FIG. 9 is that the interactive module and the proximate interactive module selectively record actions or responses that are associated with the received indication of an action by the other interactive module. Thus, if a user performs a defined action, but the defined action is not an expected defined action based on the received indication of the proximate interactive module's action, the detected action is not indicated to the proximate interactive module.

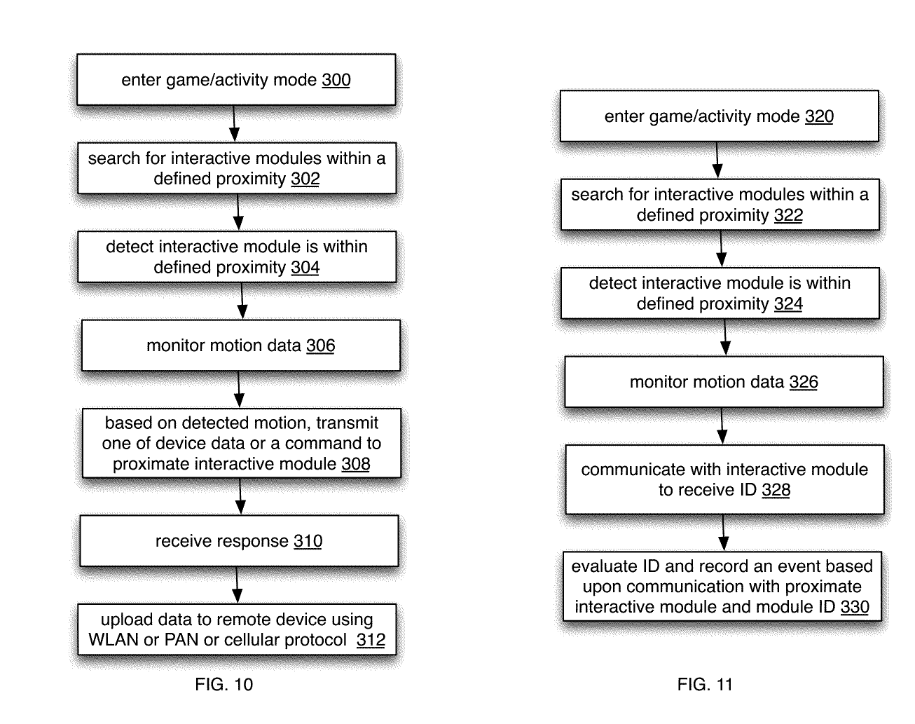

FIG. 10 is a flow chart that illustrates one aspect of an embodiment of the present invention. The method commences with the interactive module entering into a game/activity mode (300) and searching for interactive modules within a defined proximity (302). The searching may include searching for a beacon transmitted by the interactive module that can only be detected when the interactive module is within the defined proximity or it may include monitoring location data transmitted by a game/application server or game console and determining, based on the interactive module's own location information, that the other interactive module is proximate. Thus, the method includes detecting or determining that the interactive module is within defined proximity of a proximate interactive module (304).

It should be understood that steps 300-304 might occur in a different order. For example, an interactive module may not enter into a game/activity mode until after detecting or determining that another interactive module is proximate. Further more, this method may omit the step of entering into a game or activity mode of step 300. In an embodiment in which step 300 is skipped, the method merely includes interactive modules interacting with each other based upon determining that they are proximate as defined in the subsequent steps 306-312 below.

Once another interactive module has been determined to be proximate, the method includes monitoring motion data (306) and, based on a detected motion, transmitting either device data or a command to the proximate interactive module (308) receiving response (310). The received response may be a command (e.g., to perform a defined action or motion) or a command to transmit data. Thereafter, the method includes uploading data to a remote device such as a game server, application server, or game console using one of WLAN, PAN or cellular protocol (312). Such communications include exchanges of data, rules, defined actions or motions, or commands.

FIG. 11 is a flow chart that illustrates one aspect of an embodiment of the present invention. The method includes entering game/activity mode (320) and searching for interactive modules within a defined proximity (322). Thereafter, the method includes detecting or determining that an interactive module is within defined proximity (324) and monitoring motion data of the interactive module (326). It should be understood that references herein this specification monitoring motion data includes monitoring changes in position data to define or detect a defined motion. The method further includes communicating with the proximate interactive module to receive its ID (328), evaluating the received ID and record an event based upon communication with proximate interactive module and module ID (330).

One specific aspect of this method is that the scoring or recording is based not only upon an action of either the interactive module or the proximate interactive module, but also upon the ID of the proximate interactive module. For example, if the ID is one of an interactive module that is on a different team according to the game or activity rules, then the occurrence of an action may result in the action being recorded or, inversely, not being recorded depending upon game/activity rules.

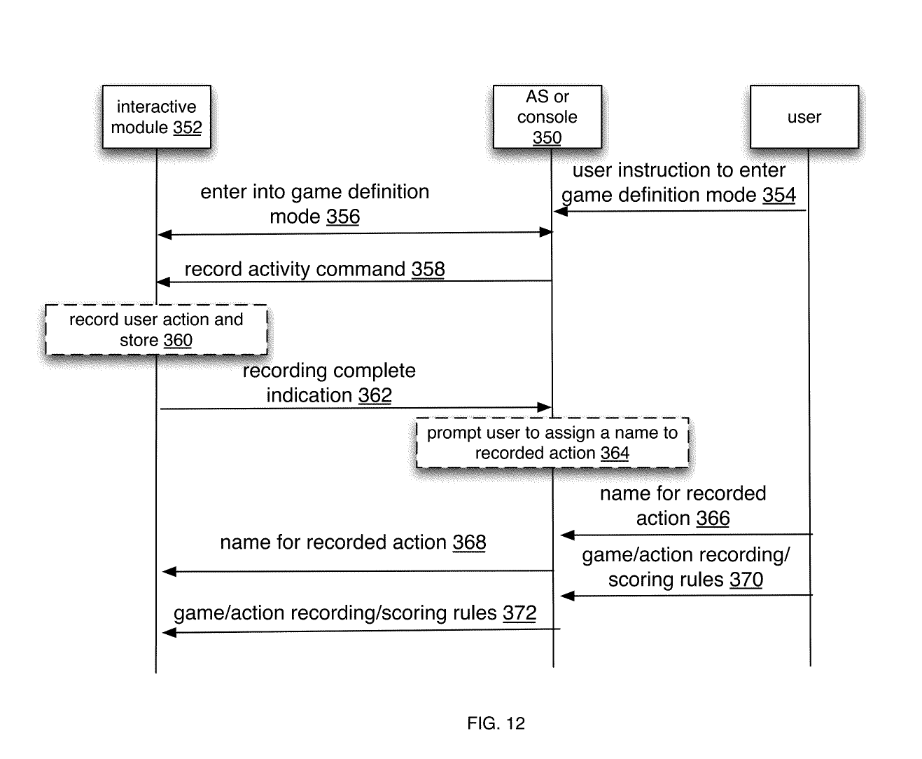

FIG. 12 is a signal flow diagram that illustrates a method according to one embodiment of the invention for defining game/activity rules. A user communicates with an application server (AS) or game console 350 that communicates with an interactive module 352. Initially, a user by way of a user interface enters an instruction to an application server (AS) or game console 350 to enter into a game definition mode (354). AS or game console 352 then transmits a command to interactive module 352 to enter into a game definition mode 356. Thereafter, AS or game console 350 transmits a record activity command 358 to prompt the interactive module 352 to capture a subsequent movement. The user then perform the action with the interactive module 352 and the interactive module 352 records the user action and stores it (360). After the action is complete and has been recorded, interactive module 352 transmits a recording complete indication to AS or game console 350 (362).

AS or game console 350, upon receiving the recording complete indication 362, prompts the user to assign a name to the recorded action (364). The user then generates a name for the recorded action (366). In one embodiment, AS or console 350 had previously received the recorded action. Accordingly, AS or game console 350 assigns the name to the recorded action. Additionally, AS or console 350 transmits the received name to the interactive module 368. Additionally, the user enters game/activity recording and scoring rules in relation, at least partially, to the recorded action 370. Finally, the AS or game console 350 transmits the game/activity recording and scoring rules to the interactive module (372).

It should be understood that one aspect of the invention described in relation to FIG. 12 is that a user, via a user interface, interacts with the AS or game console 350 and indirectly with the interactive module 352 to define actions/activities and to rules including scoring and record keeping rules in relation to the defined actions/activities. It should also be understood that the method might readily be modified by order and by what steps are included in the method. More generally, the method of FIG. 12 allows a user to create games and activities that are based upon user-defined actions.

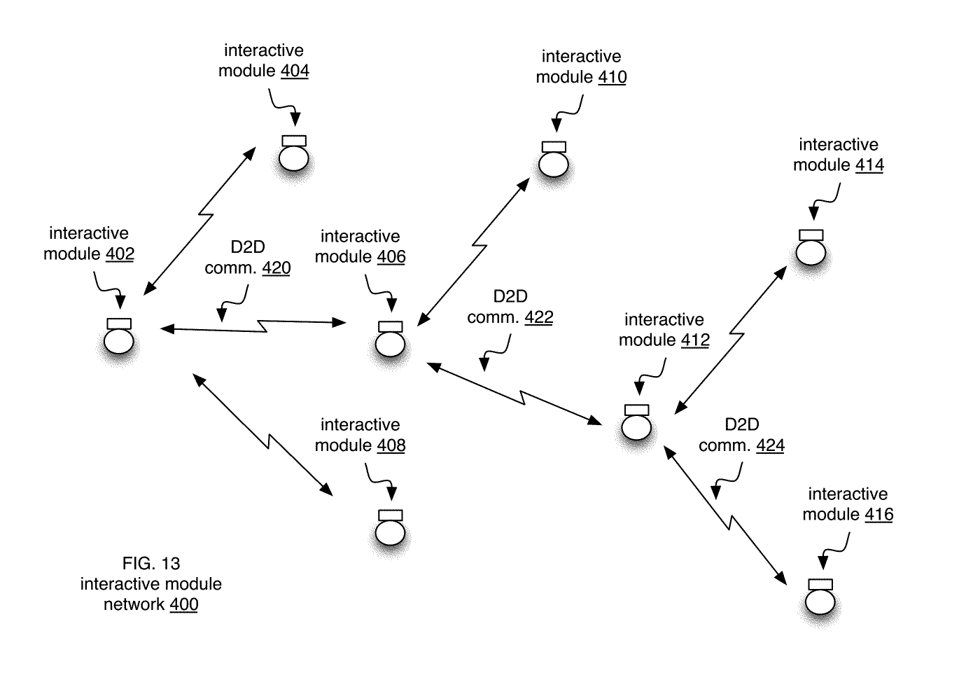

FIG. 13 is a functional diagram illustrating a network of interactive modules that operate according to one embodiment of the invention. Interactive module network 400 includes a plurality of interactive modules 402-416. One aspect of the embodiments of the invention illustrated here is that the devices are operable to engage in device-to-device (D2D) communications as is illustrated by the “bolts” between the various interactive modules 402-416. For the illustration of FIG. 13, if interactive module 402 adds a score or rule or defined action or activity, that score, rule or defined action (“the update”) may be transmitted between the various interactive modules using D2D communications. Thus, module 402 transmits the update to module 406 via D2D communication 420. Module 406 transmits the update to module 412 via D2D communication 422. Module 412 then transmits the update to module 416 via D2D communication 424.

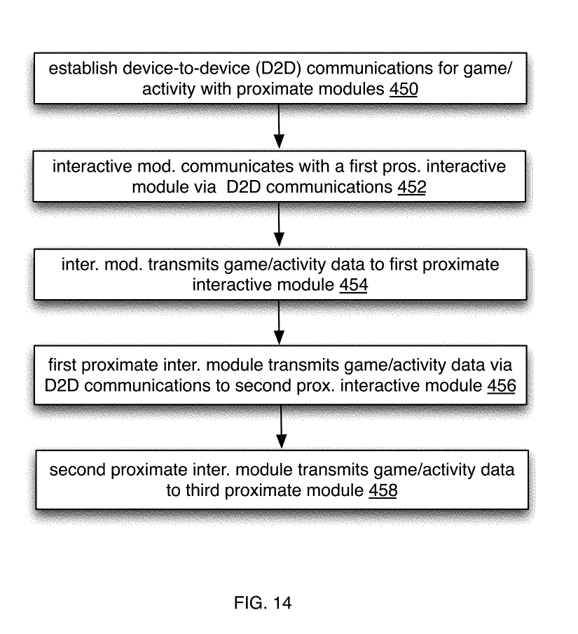

FIG. 14 is a flow chart that illustrates a method of communication in a network of interactive devices according to one embodiment of the invention. The method commences with an interactive module establishing device-to-device (D2D) communications for a game or activity with proximate modules (450). Thereafter, an interactive module communicates with a first proximate interactive device via D2D communications (452). The interactive module transmits game/activity data to the first proximate interactive module (454). The first proximate interactive module then communicates with a second proximate interactive device via D2D communications to forward the game/activity data (456). The second proximate interactive module is one that is not in communication with the first interactive device. The second proximate interactive module then transmits received game/activity data from the second proximate interactive module to a third proximate interactive module (458).

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method for a first interactive module, comprising:
determining that a second interactive module is proximate to the first interactive module;
identifying a defined motion based upon data generated data produced by at least one of an inertial measurement unit (IMU), an attitude and heading reference system (AHRS) and a magnetometer;
establishing a communication link with the second interactive module using one of a personal area network protocol or a near field communication protocol;
based on the determined proximity and the identified active motion, storing an indication of an event; and
exchanging data based upon identifying the defined active motion directly with the second interactive module.

2. The method of claim 1 wherein the step of determining that the second interactive module is proximate to the first interactive module includes at least one of:
electronically detecting the second interactive module; and
receiving location information and evaluating the location information in relation to a known location of the first interactive module.

3. The method of claim 1 further comprising:
based upon determining the second interactive module is proximate to the first interactive module, and based upon identifying the defined active motion by comparing the data corresponding to a motion or action to a library of defined moves, determining to enter into a specified game or activity mode.

4. The method of claim 1 wherein the step of identifying the defined active motion based upon data generated by at least one of position determination circuitry and acceleration circuitry.

5. The method of claim 6 wherein the library of movements in relation to established rules creates a language of commands, data exchanges, and responses between the first and second interactive modules.

6. The method of claim 1 further comprising:
receiving a radio frequency signal from a remote device that is not an interactive module to enter into a specified game or activity mode.

7. The method of claim 6 further including receiving at least one of:
game data;
activity data of other interactive modules; and
rules for a game.

8. The method of claim 6 further including pushing data to the remote device that relates to the specified game or activity.

9. An interactive module, comprising:
at least one of an inertial measurement unit (IMU), an attitude and heading reference system (AHRS) for detection position and motion, and magnetometer;
an action defining module;
a defined action recognition module;
a game/activity defining module;
communication circuitry; and
wherein the interactive module is configured to:
generate or receive game/activity rules or motions;
recognize specific motions in relation to a stored game/activity rules or motions and to maintain a record of the specific motions in relation to the stored game/activity rules; and
exchange game/activity related data communications with a second interactive module; and
communicate game/activity related data and rules with one of a second interactive module, an activity server or base unit.

10. The interactive module of claim 9 configured for determining that a second interactive module is proximate to the first interactive module.

11. The interactive module of claim 10 configured for utilizing at least one of the IMU, AHRS and the magnetometer to identify a defined active motion based upon data generated by at least one of IMU and AHRS and the magnetometer.

12. The interactive module of claim 10 configured for:
establishing a communication link with the second interactive module using one of a personal area network protocol, a WLAN communication protocol or a near field communication protocol;
based on the determined proximity and the identified active motion, storing an indication of an event; and
exchanging data with the second interactive module.

13. The interactive module of claim 10 configured for at least one of:
receiving a radio frequency signal from a remote device that is not an interactive module to enter into a specified game or activity mode; and
based upon determining the second interactive module is proximate to the first interactive module, and based upon identifying the active motion, determining to enter into a specified game or activity mode.

14. The interactive module of claim 10 configured for identifying the defined active motion based upon data generated by at least one of the IMU or AHRS further includes comparing the data to a library of defined moves.

15. The method of claim 14 wherein the library of movements in relation to established rules creates a language of commands, data exchanges, and responses between the first and second interactive modules.

16. A method for a first interactive module, comprising:
receiving proximity data identifying that a second interactive module is proximate to the interactive module;
receiving motion data identifying that a defined motion has occurred;
identifying whether the motion data identifies a defined motion within a certain tolerance;
evaluating game/activity rules based on the defined motion;
based on the game/activity rules, the proximity data and the motion data, determining to record an event; and
maintaining a cumulative total of recorded events.

17. The method of claim 16 further including receiving and evaluating GPS data as a part of determining to record the event.

18. The method of claim 16 wherein the game/activity rules are for one of the following games/activities:
brushing teeth;
exercising;
shaking hands;
hugging; and
dancing.

19. The method of claim 16 further including receiving location data identifying that the second interactive module is proximate to the first interactive module.

20. The method of claim 19 wherein the type of event recorded is based upon an ID of the second interactive module.

21. The method of claim 16 wherein a plurality of interactive modules including the first and second interactive modules are arranged to communicate via a mesh networking protocol and further including exchanging game/activity data utilizing mesh network communication protocols.

22. The method of claim 21 further including:
receiving game/activity data from the second interactive module; and
transmitting the received game/activity data to a third interactive module that is not in communication with the second interactive module.
